(19) United States
(12) Patent Application Publication
(10) Pub. No.: US 2010/0062654 A1
(43) Pub. Date: Mar. 11, 2010

(54) ELECTRICAL CONNECTOR WITH A SUSTAINING MEMBER

(75) Inventors: GAO-BING LEI, Shenzhen (CN); NAN HU, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/549,406

(22) Filed: Aug. 28, 2009

(30) Foreign Application Priority Data
Sep. 9, 2008 (CN) 200820185544.X

(51) Int. Cl. H01R 24/00

(52) U.S. Cl. 439/660

(57) ABSTRACT

An electrical connector includes: an insulating housing having a pair of sidewalls, a pair of endwalls and a bottom wall for defining a receiving room therebetween; a number of contacts retained in the insulating housing, each contact having a retaining beam, a moveable spring beam extending into the receiving room and a soldering leg extending from the retaining beam; and a sustaining member retained in the insulating housing and having a plurality of spring fingers located under the spring beam for sustaining said spring beam. The spring finger can provide an enough flexibility to the spring beam and also prevent the spring beam from being over distorted during a mating process.

### BACKGROUND OF THE INVENTION

1. Field of the invention

The present invention relates to an electrical connector which is mounted on a PCB (printed circuit board) and electrically mates with a mating object.

2. Description of Related Art

An electrical connector assembly is used in an electronic device to connect with two PCBs electrically. As disclosed in FIG. 1 and FIG. 2, an electrical connector assembly includes a plug connector 2′ and a receptacle connector 3′ mating with said plug connector 2′. Said plug connector 2′ includes an first insulating housing 21′ and a plurality of first contacts 22′ retained in said first insulating housing 21′. Said receptacle connector 3′ includes a second insulating housing 31′ and a plurality of second contacts 32′ retained in said second insulating housing 31′. Said second contact 32′ includes a retention portion 321′ and a contacting beam 322′ extending from the retention portion 321′ for contacting with said first contacts 22′. Said contacting beam 322′ and said retention portion 321′ are connected by an arc portion 323′. During the mating process, the first contact 22′ mates with the contacting beam 322′ of the second contact 32′ while said arc portion 323′ has a distortion and generates a flexibility for the contacting beam 322′. However, the flexibility provided by the arc portion 323′ will become weaker in a low profile electrical connector with a small size, which may lead an unstable mating process between said first contact 22′ and second contacts 32′. Moreover, the arc portion 323′ will become easy to be broken after the many times of mating with said first contact 22′.

So it is necessary to provide a new electrical connector to solve the problems above.

### SUMMARY OF THE INVENTION

Accordingly, it is an object of the present invention to provide a new electrical connector which provides an stable connection.

In order to achieve above-mentioned object, an electrical connector is provided and comprises: an insulating housing having a pair of sidewalls, a pair of endwalls and a bottom wall for defining a receiving room therebetween; a plurality of contacts retained in the insulating housing, each contact having a retaining beam, a moveable spring beam extending into the receiving room and a soldering leg extending from said retaining beam; and a sustaining member retained in the insulating housing and having a plurality of spring fingers located under said spring beam for sustaining said spring beam.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of an electrical connector used in a prior art;

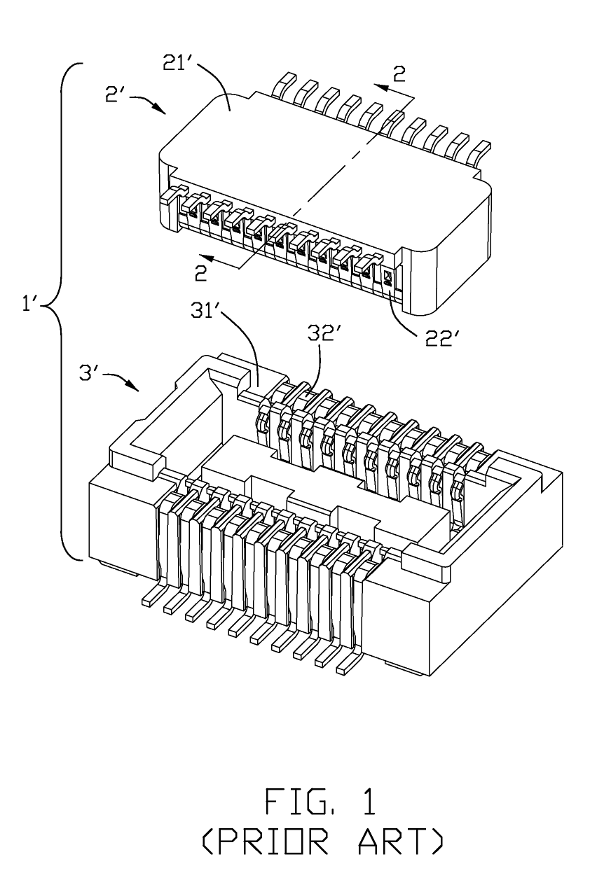

FIG. 2 is a cross-section view of the electrical connector taken along 2-2 of FIG. 1;

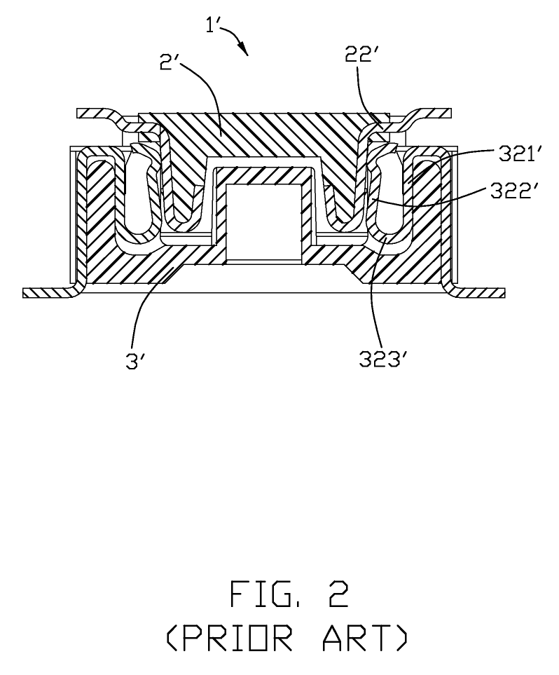

FIG. 3 is an assembled perspective view of the electrical connector assembly according to the present invention;

FIG. 4 is a perspective view of the electrical connector assembly according to the present invention;

FIG. 5 is another perspective view of the electrical connector assembly of FIG. 4;

FIG. 6 is an exploded perspective view of the electrical connector assembly of FIG. 4;

FIG. 7 is a cross-section view of the electrical connector taken along 7-7 of FIG. 4; and

FIG. 8 is a cross-section view of the electrical connector assembly taken along 8-8 of FIG. 3.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

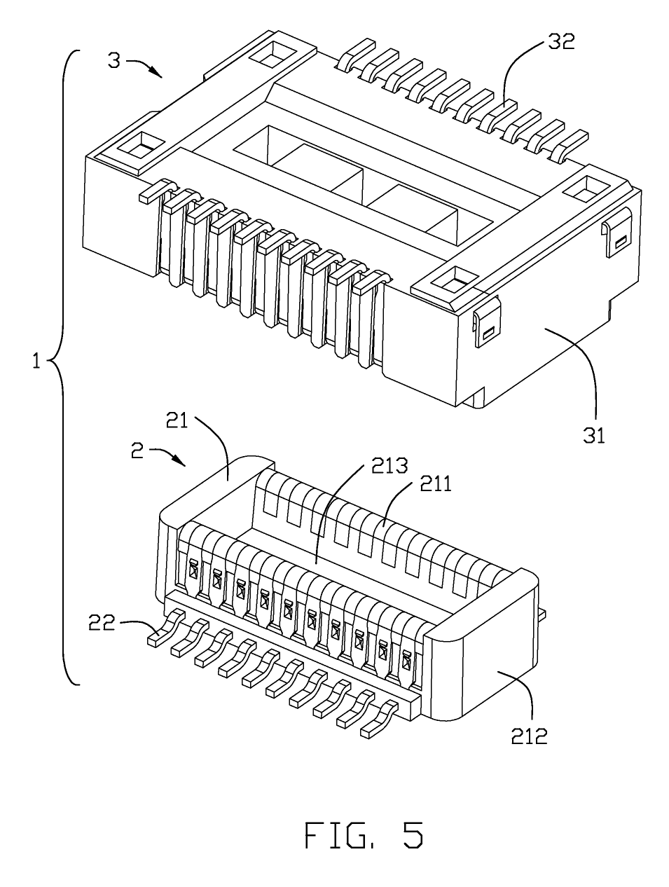

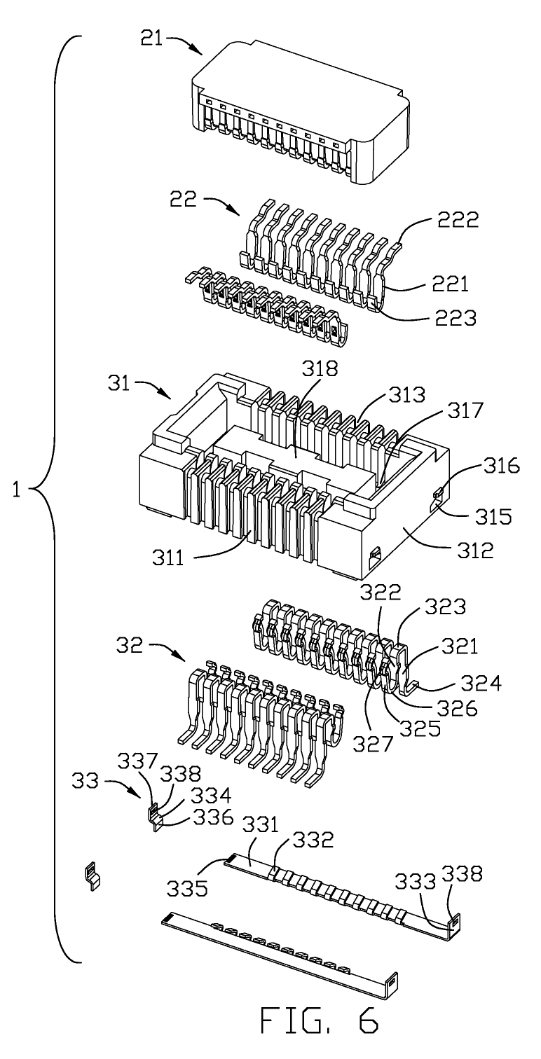

In FIGS. 5 and 6, the electrical connector assembly includes an electrical connector 3 and a mating connector 2. The electrical connector 3 includes an insulating housing 31, a plurality of contacts 32 retained in the insulating housing 31 and a pair of sustaining member 33 retained in said insulating housing 31 for sustaining said contacts 32.

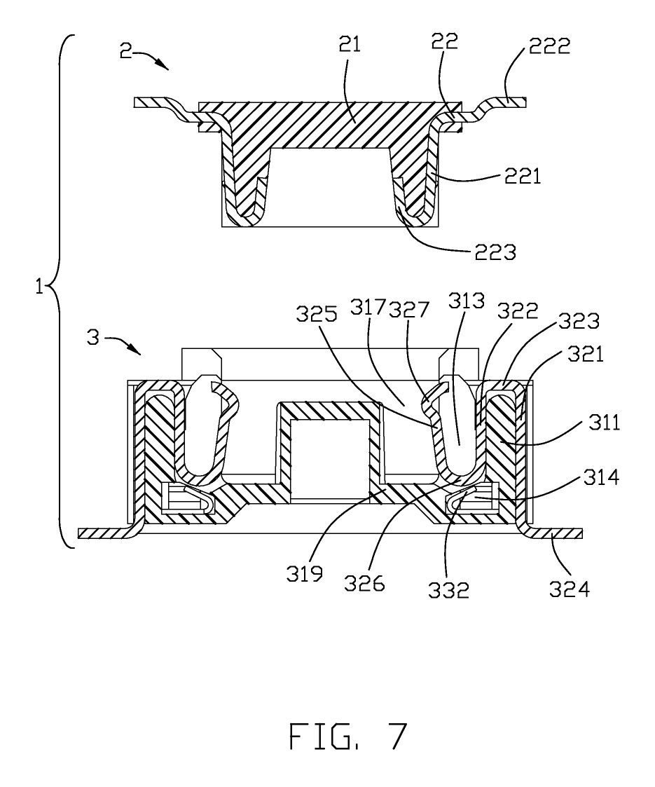

The insulating housing 31 has a pair of longitudinal sidewalls 311, a pair of endwalls 312 connecting with said sidewalls 311 to define a receiving room 317 therebetween and a mating portion 318 extending upwardly into the receiving room 317 from a bottom wall 319 of the insulating housing 31 shown in FIG. 7. The sidewall 311 defines a plurality of passageways 313 on an outer face and inner face thereof for receiving said contacts 32 and a pair of receiving groove 314 for receiving the sustaining member 33. Said receiving grooves 314 are formed on the bottom wall 319 of the insulating housing 31 along a longitudinal direction and located under said passageways 313. The receiving grooves 314 extend horizontally to a lower portion of the sidewall 311 and run through to the passageways 313. Said receiving grooves 314 extend longitudinally along the sidewalls 311 and run through the endwalls 312 to define a pair of retaining holes 315. Said endwall 312 has a protruding portion 316 protruding from an outer surface thereof and located on a top side of said retaining hole 315.

As referring to FIG. 6 and FIG. 7, the contact 32 is downwardly assembled onto the insulating housing 31 and retained in the passageways 313. Said contact 32 includes a first retaining beam 321 retained on the outer side of the sidewall 311, a second retaining beam 322 retained on the inner side of the sidewall 311, a connecting beam 323 connecting with said first and second retaining beam 321, 322, a soldering leg 324 extending out of the insulating housing 31 from a lower portion of the first retaining beam 321 and a contacting beam 325 extending into the receiving room 317. The first retaining beam 321, second retaining beam 322 and the connecting beam 323 defines a reverse U-shaped structure which securely clamps the sidewall 311. The contacting beam 325 and the second retaining beam 322 are connected by a U-shaped arc portion 326 for providing an enough flexibility to said contacting beam 325. Said U-shaped arc portions 326 are located on a top side of the receiving grooves 314 for contacting with the sustaining member 33. Said contacting beam 325 extends upwardly and has a tip end defining a mating portion 327 mating with the mating connector 2. Said contacting beam 325 and the U-shaped arc portion 326 form a moveable spring beam of the contact 2 to engage with the mating connector 2.

As referring to FIG. 6, the sustaining member 33 is formed in a longitudinal shape and assembled into the receiving groove 314 horizontally from the retaining hole 315 of the endwall 312. Said sustaining member 33 includes a longitudinal base portion 331, a plurality of spring fingers 332 extending upwardly and slantly from a lateral edge of the base portion 331, a first retaining tab 333 bended upwardly from one longitudinal end of said base portion 331 and a second retaining tab 334 engaging with another longitudinal end of the base portion 331. The base portion 331 defines an engaging slot 335 on said another longitudinal end for engaging with the second retaining tab 334. Both the second retaining tab 334 and the retaining tab 333 define a locking hole 338 engaging with said protruding portion 316. The second retaining tab 334 further has a holding leg 336 engaging with said engaging slot 335 of the base portion 331. Said sustaining members 33 are retained in the receiving grooves 314, and the spring fingers 332 of the sustaining members 33 are located under the contacts 32 respectively and upwardly extend toward said U-shaped arc portion 326 in order to sustain the U-shaped arc portion 326 upwardly during the mating process. As a result, the spring fingers can provide an enough flexibility to the U-shaped arc portion 326 and also prevent the U-shaped arc portion 326 from being over distorted. Said spring fingers 332 is made of metal but covered by insulating material to avoid an electrical short between the contacts 32. Furthermore, the spring finger 332 extends slantly toward the sidewall 311 so that it can prevent the U-shaped arc portion 326 from moving toward the sidewall 311.

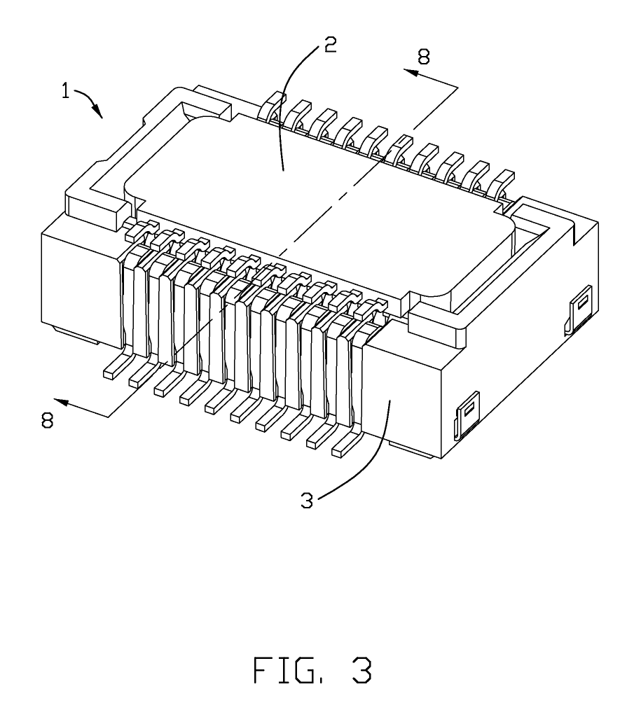

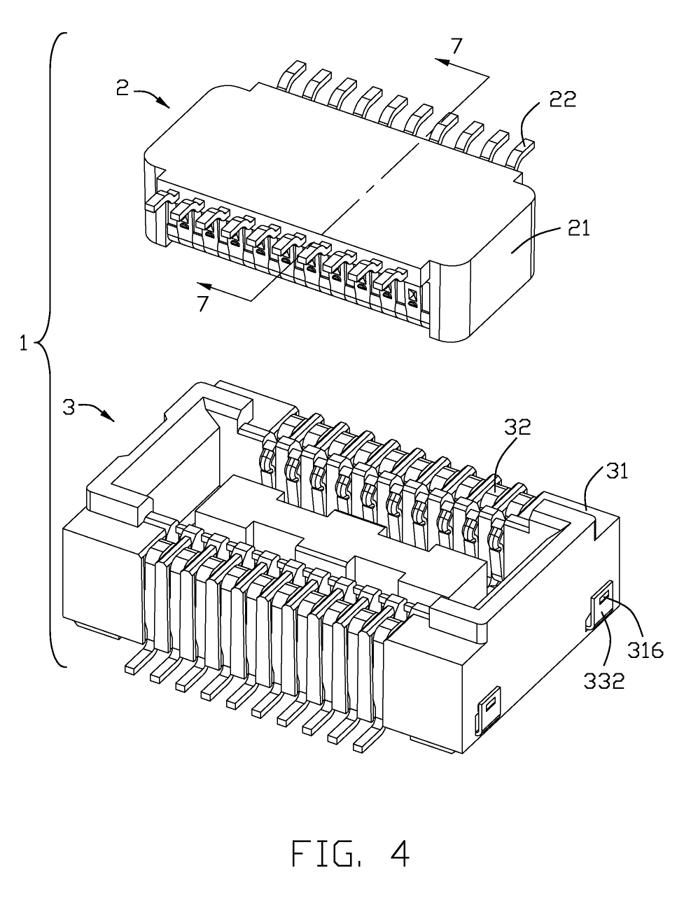

Referring to FIG. 3 to FIG. 6, the mating connector 2 includes an insulating body 21 and a plurality of terminals 22 retained in the insulating body 21. Said insulating body 21 has a pair of longitudinal sidewalls 211 and a pair of endwalls 212 connected with said sidewalls 211. Said sidewalls 211 and endwalls 212 define a receiving space 213 therebetween for receiving the electrical connector 3. Said terminal 22 includes a contacting portion 221, a soldering portion 222 extending from a bottom end of the contacting portion 221 and a locking portion 223 extending into the receiving space 213 from a top end of the contacting portion 221.

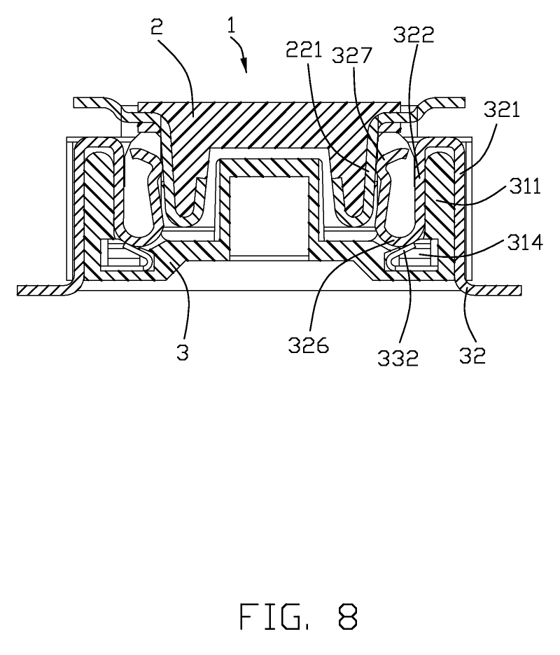

In FIG. 8, after the electrical connector 3 mates with the mating connector 2, the contacts 32 of the electrical connector 3 are engaged with the terminals 22 and generate a distortion downwardly, said spring fingers 332 of the sustaining members 33 upwardly sustains the U-shaped arc portions 326 to provide an enough flexibility to the contacting beams and also prevent the contacting beams 325 from being over distorted.

However, while the preferred embodiment of the invention have been shown and described, it will apparent to those skilled in the art that changes and modifications may be made therein without departing from the spirit of the invention, the scope of which is defined by the appended claims.

What is claimed is:

1. An electrical connector comprising:
an insulating housing having a pair of sidewalls, a pair of endwalls and a bottom wall to commonly define a receiving room therebetween;
a plurality of contacts retained in the insulating housing, each contact having a retaining beam, a moveable spring beam extending in the receiving room and a soldering leg extending from said retaining beam; and
a sustaining member retained in the insulating housing and having a plurality of spring fingers located under said spring beam for sustaining said spring beam.

2. The electrical connector as claimed in claim 1, wherein said moveable spring beam includes a contacting beam and an arc portion connecting with said contacting beam and said retaining beam.

3. The electrical connector as claimed in claim 1, wherein said insulating housing defines a plurality of passageways receiving said contacts and a receiving groove located under said passageways receiving said sustaining member.

4. The electrical connector as claimed in claim 1, wherein the sustaining member includes a longitudinal base portion retained in the sidewall of the insulating housing, said spring fingers are formed on a lateral edge of the base portion and extend upwardly toward the spring beam.

5. The electrical connector as claimed in claim 4, wherein said spring fingers are made of metal and covered by insulating material.

6. The electrical connector as claimed in claim 5, wherein the spring finger extends slantly toward the sidewall.

7. The electrical connector as claimed in claim 1, wherein the endwall of the insulating housing has a retaining hole retaining said sustaining member and a protruding portion on a top side of the retaining hole engaging with the sustaining member.

8. The electrical connector as claimed in claim 7, wherein the sustaining member is horizontally assembled into the insulating housing from said retaining hole of the endwall.

9. An electrical connector comprising:
a plurality of contacts each comprising a retaining beam, a contacting beam extending from the retaining beam and a soldering leg; and
an insulating housing loaded the plurality of contacts, the retaining beam of the contact abutting against the housing, the contacting beam in a receiving room defined in the housing and no-supported by housing;
a sustaining member assembled into the housing, the sustaining member defining a plurality of non-conductive spring fingers aligned with the contacts;
wherein the spring fingers projecting in a direction opposite a mating direction of the electrical connector to prevent the contacting beams over-move in the mating direction.

10. The electrical connector as claimed in claim 9, wherein the spring fingers are aligned with tips of U-shaped portions connecting with the contacting beams and the retaining beams.

11. An electrical connector comprising:
an insulative housing defining an upward mating port;
a plurality of contacts disposed in the housing with corresponding resilient contacting sections exposed in the mating port and adapted to be deflected in both a vertical direction and a lateral direction relative to the mating port; and
a resilient sustaining structure located below each resilient contacting section;
wherein
when a complementary connector is inserted into the mating port, downwardly movement of the resilient contacting section results in a bottom area of the contacting section engages the resilient sustaining structure for obtaining an auxiliary support.

12. The electrical connector as claimed in claim 11, wherein said sustaining structure is formed on an external piece inserted into the housing.

13. The electrical connector as claimed in claim 12, wherein said external piece is inserted into the housing in a longitudinal direction perpendicular to both said vertical direction and said lateral direction.
